(19) United States
(12) Patent Application Publication
(10) Pub. No.: US 2003/0233315 A1
(43) Pub. Date: Dec. 18, 2003

(54) Bidding in multiple on-line auctions

(76) Inventors: Andrew Robert Byde, Bristol (GB); Christopher William Preist, Bristol (GB)

Correspondence Address: HEWLETT-PACKARD COMPANY, Intellectual Property Administration, P.O. Box 272400, Fort Collins, CO, 80527-2400, US

(21) Appl. No.: 10/374,361

(22) Filed: Feb. 25, 2003

(30) Foreign Application Priority Data
Feb. 26, 2002 (GB) 0204429.5

(51) Int. Cl. G06F 17/60

(52) U.S. Cl. 705/37

(57) ABSTRACT

A method of determining a bidding strategy for purchasing a plurality of goods from a plurality of different types of on-line auctions is described. The method comprises: accessing probabilistic belief models for each of the plurality of different types of auctions; considering combinations of bids in each specific auction type for the plurality of different types of auctions; removing each possible bid of the combination of bids which fails to meet a predefined constraint of that type of auction for the plurality of different types of auctions, by use of the probabilistic belief models; estimating the expected benefit of each possible combination of bids across different types of auctions by use of the probabilistic belief models; and selecting the combination of bids across different types of auction which provides the highest expected benefit, for use as the bidding strategy.

### TECHNICAL FIELD

The present invention concerns improvements relating to bidding in multiple on-line auctions. It relates particularly, although not exclusively, to the provision of bidding advice for the purchasing of similar goods from multiple on-line or electronic auctions by providing a simplfied estimate of the future utility of bidding in auctions of different types.

### BACKGROUND ART

On-line auctions are becoming increasingly popular for the trading of goods and services between, and amongst, businesses and consumers. Goods as varied as art and antiques, jewellery, consumer electronics, tickets for sporting events, and furniture, and services such as thc provision of legal advice, delivery services and advertising space, may all be acquired from on-line auctions.

Different auction houses conduct various types of auctions, the most popular auction types being English, Dutch, first-price sealed bid and second-price sealed bid (or Vickrey) auctions in an English auction, the auctioneer commences with the lowest price that would be acceptable to the seller, and bidders are at liberty to raise their bids until there are no more offers. The winner of the goods is the bidder who has put forward the highest bid. A Dutch auction is the opposite of an English auction. Instead of starting with the lowest price the seller will accept for his goods, the auctioneer calls for an initial high price. When no offers are received from the bidders, the price is reduced by a fixed decrement value. The price is then progressively lowered until there is an offer from a bidder. The first bidder to offer a price wins the goods. If there is more than one bidder who is interested at the same price, the item will be sold to the bidder who offered to buy the item first.

In a first-price sealed bid auction, the bidders all submit independent offers for the goods. The buyer who has offered the highest bid wins the goods and the price he pays for the goods is equal to the amount he has bid. A Vickrey auction is similar to the first-price sealed bid auction, except that the goods are sold to the highest bidder at the price bid by the second highest bidder. The bidding and clearing strategies for each of these types of auction are summarised in Table 1 of FIG. 1.

Over the last few years, there has been a tremendous increase in the number of on-line auction houses, and it is estimated than there are now more than 500 auction houses carrying out business over the Internet. One of the most popular on-line auction houses is found at “www.eBay.com” where there are sometimes over ten million items for sale at any one time, and approximately 42 million registered users throughout the world. Due to the proliferation of such auction houses, buyers and sellers need to be able to monitor many different auctions taking place at many different sites in order to determine the best set of auctions in which to participate, and how best to bid in their chosen auctions in order to obtain the best price, either as a buyer or a seller. Bidders also need to determine the value to bid in the auction in order to maximize their chances of obtaining the goods.

Considering auctions in which single items are for sale, particular tactics should be adopted by bidders if they are to do well (i.e. to win the goods at the best possible price). Usually, each bidder has his own private valuation of the item that he wishes to purchase, which is not known to other bidders (known as the private valuation model). If this model is used in an English auction, the strategy is to always bid a small amount more than the current highest bid, and to stop when the private valuation has been reached. For first-price sealed bid auctions, the objective is for a bidder to bid less than his private valuation—how much less depends on how high the bidder thinks the other bidders might bid. In general, the bidder will bid lower than the price needed to guarantee a win. In a Dutch auction, the bidder must choose the price level at which he will try to claim the item. This is the same way the winner and the price are determined in the first-price sealed bid auction. In Vickrey auctions, each bidder puts forward a bid without having any knowledge of the values of the other bids. The bidder's best strategy is to bid his true valuation. The above tactics work well in single auctions, but they do not work for multiple auctions, especially multiple auctions of different types.

When considering multiple auctions, bidders need to choose which auction(s) to take part in, and are faced with the additional problem of making hie correct bid to ensure that they get the item of their choice in accordance with their private valuation of the item/goods. This is a time consuming task particularly when individual auctions have different start and end times. What is more, auctions can last for a few days, or even weeks if unusual or very expensive goods are being auctioned, and it is apparent that a bidder would not be able to stay awake in front of his computer for a few days in order to monitor the bidding and place bids.

In light of these issues, consumers are inclined to concentrate on a single auction of their choice. Unfortunately, winning in that auction does not necessarily mean that they get the best deal, as they may have received a better price in another auction. To address these shortcomings, bidding in on-line auctions may be automated. This is usually achieved by building a software agent that acts on behalf of a consumer and is given capabilities such as the ability to search on-line auctions, to negotiate with sellers and to make purchases autonomously. More specifically, the consumer only needs to supply the maximum bid value to the bidding robot, and it will then automatically increment the bid value progressively while the auction is ongoing. It stops bidding when the maximum price is reached. The agent must ensure that it never bids above the reservation price (the maximum amount that the consumer is willing to pay) and it tries to get the item in a manner that is consistent with the consumer's preferences (e.g. at the earliest time, at the lowest price, or with the maximum chance of succeeding). While freeing the consumer to a certain extent, this type of facility limits the choice of auctions in which a consumer can participate. If the consumer wishes to purchase the item, he has to wait until the auction is concluded before he bids in another auction to avoid getting multiple items.

Designing bidding agents for participating in multiple on-line auctions is not a simple task. In the multiple auctions scenario, the consumer is faced with problems of not knowing when the auctions will terminate, which bids are likely to win in which auctions and what is the right bid value, and of taking into account the different protocols of the different auction types. The bidding agent therefore needs to select bids from a whole set of possible bids. This may be achieved by working out the expected utility (i.e. the product of the probability of the agent winning in that auction at the given bid value and the value of the agent's utility function). A utility function assigns to each possible outcome (in terms of number of goods bought and total money spent) a numerical value, indicating how preferred that outcome is. The expected utility of all combinations of bids in many simultaneous auctions may be calculated, and the set of bids in auctions with the highest expected utility is picked as the target set of auctions, i.e. the auctions in which the agent should bid

To get an accurate measure of the expected utility of the future auctions given certain beliefs about opponents' bidding behaviour, it is necessary to have complete information about the structure of future auctions (i.e. starting time, rule determining closing time, times when bids can be submitted, times for bids to be processed and accepted/rejected, etc). Given this, it is theoretically possible to calculate the exact expected utility of future auctions by modelling then as a Markov Decision Process, and determining optimal bid-choices using backward induction through Dynamic Programming (see, for example, A. Byde “A dynamic programming model for algorithm design in simultaneous auctions”, in Proc. WELCOM '01, Heidelberg, Germany, LNCS. Springer Verlag 2002; C. Boutilier et al “Sequential auctions for the allocation of resources with complementaries” in Proc. UCAI '99; and Boutilier et al “Continuous value function approximation for sequential bidding policies” in Poc. UAI '99).

Although possible in theory, such a solution is highly complex for problems of significant size, and so would be very difficult to calculate rapidly enough in real-time for use in real on-line auctions. Furthermore, some of the information necessary for a complete model (particularly that relating to bid process times, etc) would be difficult to obtain accurately.

By making the simplifying assumption that all auctions proceed in synchronised rounds, the modelling problem is significantly reduced and the approach becomes more feasible, at least for situations where the number of auctions open at any one time is relatively low (#6). However, it is sought to address a less constrained problem i.e., one in which auctions do not necessarily all proceed in synchronized rounds, and so the backward induction model is rejected as a practical solution to the problem of finding optimal bid choices for bidding in multiple auctions. Other methods which have been used to calculate optimal bid-choices in multiple auctions are mentioned below.

Anthony et al. (“Autonomous agents for participating in multiple on-line auctions” in Proc. UCAI Workshop on E-Business and the Intelligent Web” pp. 54-64, 2001) describe a heuristic method tat covers English, Dutch, first and second price sealed-bid auctions, but the method may only be used to purchase a single item and does not have a clear analytical framework underpinning its operation.

Preist et al. (“Algorithm design agents which participate in multiple simultaneous auctions”, Agent Mediated Electronic Commerce III, Lecture Notes in AI. Springer Verlag, September 2001) have developed algorithms for agents to participate in multiple English auctions for the purchase of a number of similar goods. However, due to the complexity of the mathematics involved, this method does not readily extend to the purchase of similar goods from multiple auctions with different protocols/types.

Finally, Ito et al. have developed a system known as “BiddingBot” as a decision support aid for users operating over multiple auctions (see “A multiple support system for cooperative bidding in multiple auctions” in Proc. 4th Int. Conf. on Multi-Agent Systems, pp. 182-189, 2000). The drawback of this system is that it merely presents choices to the user rather than actually making the purchasing decisions itself.

One aim of the invention is to provide a method for providing bidding advice for the purchase of similar goods from multiple on-line auctions of a different type, which overcomes the above mentioned difficulties. Another aim of the invention is to provide a computationally efficient means of carrying out this method so that it may be used in real-time.

### SUMMARY OF THE INVENTION

According to a first aspect of the invention there is provided a method of determining a bidding strategy for purchasing a plurality of goods from a plurality of different types of on-line auction, the method comprising: accessing probabilistic belief models for each of the plurality of different types of auctions; considering combinations of bids in each specific auction type for the plurality of different types of auctions, removing each possible bid of the combination of bids which fails to meet a predefined constraint of that type of auction for the plurality of different types of auctions, by use of the probabilistic belief models; estimating the expected benefit of each possible combination of bids across different types of auctions by use of the probabilistic belief models; selecting the combination of bids across different types of auction which provides the highest expected benefit, for use as the bidding strategy.

Preferably, all possible combinations of bids are considered.

As discussed in the introduction, it is very difficult for a human to simultaneously track a number of on-line auctions, particularly if the auctions are of different types. The method of the present invention advantageously provides a method of automating this process so that a user knows which bids to place (or not to place) in auctions in order to obtain goods at the best possible prices. This is aided by the provision of probabilistic belief models which specify the likelihood of obtaining the goods at a given price. Preferably a separate probabilistic belief model is provided for each different type of auction for a particular good or goods of a similar nature. Most preferably separate probabilistic belief models are provided for each specific auction in a single Ape of auction. However, one model for all auctions irrespective of auction type (or indeed any other combination of models) may be provided.

Preferably the plurality of different types of on-line auctions includes at least two of the following auction types: English, Dutch and sealed-bid auctions, where the sealed-bid auctions include both first-price and second-price sealed bid auction. However, the method may also be used for any other suitable type of auction.

The method preferably includes obtaining the closing prices of specific auctions in the plurality of different types of auctions for identical or similar goods to the plurality of goods, and creating a probabilistic belief model for at least each different type of auction from the closing price information. As closing prices of auctions for certain goods may not be available for use in the method, the likelihood of obtaining such goods for a particular price may be estimated by an expert.

The method may also comprise monitoring the status of the plurality of on-line auctions and retrieving auction data from each auction, the auction data including the current price for on-going auctions, and the closing price in closed auctions in which the bidding strategy has been implemented. The closing price in these closed auctions is preferably used to update the probabilistic belief model for that type of auction, giving a more accurate model and therefore a more accurate estimate of the benefit of the possible combination of bids.

Depending on the type of auctions to which the method is applied, different properties of the auctions are used to prune the set of all possible bids. For English and Dutch auctions, the removing step preferably comprises removing a possible bid in a single auction which is not preferred by virtue of its current price and likelihood of winning at the current price as determined by the probabilistic belief model for that auction, a second auction being preferred to a first auction if the current price of the first auction is at least equal to the current price of the second auction, the likelihood of winning at the current price of the first auction is at most equal to the likelihood of wining at the current price of the second auction, and at least one of these conditions is not equal.

For a sealed-bid auction, thc removing step preferably comprises removing a possible bid in an imminent sealed-bid auction which is not preferred by virtue of its bid value and the likelihood of winning with the respective bid value as determined by the probabilistic belief model for that auction, a second bid value in a second imminent scaled-bid auction being preferred to a first sealed bid value in a first imminent sealed-bid auction when tile likelihood of winning the second auction with the second bid value at least equal to the likelihood of winning the first auction with the second bid value, the bid value in the first auction is at most equal to the bid value in the second auction, and at least one of these conditions is not equal

The above steps of removing bids from the set of all possible bids reduces the number of bids which have to be considered by the method, removing those bids which are not likely to win. The effect of removing bids also provides the advantage of making the method faster to evaluate, and therefore the method can be used in real-time for real-world on-line auctions.

The method may be simplified somewhat (and therefore speeded up) by predetermining bid values to be used in the method. This may be achieved by setting an upper limit on the bid value for each type of the plurality of different types of auction (known as a fixed-threshold threshold), or by setting a minimum bid value which guarantees winning an auction for any Dutch and/or English auction, or a minimum bid value of zero for any sealed-bid value auction (known as a fixed auction strategy).

A further advantage of the method is that no account need be taken of the order in which the auctions occur. So, for example, auctions which are currently taking place do not take precedence over auctions which will take place in the future. Thus, the method gives the choice of wailing to bid in a later (i.e. future) auction in which there is a higher probability of obtaining the goods and/or obtaining the goods at a good price.

According to a second aspect of the invention there is provided a method of bidding in a plurality of different types of on-line auctions to acquire a plurality of goods, the method comprising determining a bidding strategy according to the above described method, and executing the bidding strategy with the plurality of on-line auctions.

Preferably the method of bidding is carried out by an agent. However, the method of determining the best bidding strategy may be carried out by a separate software (or even a dedicated hardware) module, and the bidding strategy provided to one or more agents to implement at the various on-line auctions.

According to a Gird aspect of the invention there is provided a system for determining a bidding strategy for purchasing a plurality of goods from a plurality of different types of on-line auction, the system comprising: probabilistic belief models for each type of different auction; and processing means arranged to: access the probabilistic belief models for each of the plurality of different types of auctions; consider combinations of bids in each specific auction type for the plurality of different types of auctions; remove each possible bid of the combination of bids which fails to meet a predefined constraint of that Ape of auction for the plurality of different types of auctions, by use of the probabilistic belief models, estimate the expected benefit of each possible combination of bids across different types of auctions by use of the probabilistic belief models; and select the combination of bids across different types of auction which provides the highest expected benefit, for use as the bidding strategy.

Preferably, all possible combinations of bids are considered.

The present invention may also be considered to cover a data carrier comprising a computer program arranged to configure a computer to implement the methods as described above.

### BRIEF DESCRIPTION OF DRAWINGS

A presently preferred embodiment of the invention will now be described, by way of example only, with reference to the accompanying Figures, in which—

FIG. 1 shows is a table showing bidding rules, clearing rules and the winner of English, Dutch, first-price sealed bid and second-price sealed bid (Vickrey) auctions;

FIG. 2 is a diagram of a client-server system suitable for implementing the presently preferred embodiment of the present invention;

FIG. 3 is a flow diagram showing an overview of the method of generating optimal bid-choices according to the presently preferred embodiment of the present invention;

FIG. 4 is a flow diagram showing the method steps of providing details of user requirements to a software agent according to the present embodiment of the invention;

FIG. 5 is a simplified representation of the software agent interface of FIG. 4,

FIG. 6 is a glossary of the variables utilised in the mathematical reasoning behind the method of the present invention,

FIG. 7 is a probabilistic belief function showing the probability P(x) of winning a good at a price x as used in the method of the present embodiment of the invention;

FIG. 8a shows a top level algorithm for determining the optimal set of bids; and

FIG. 8b shows a lower level algorithm for determining the estimate of the utility.

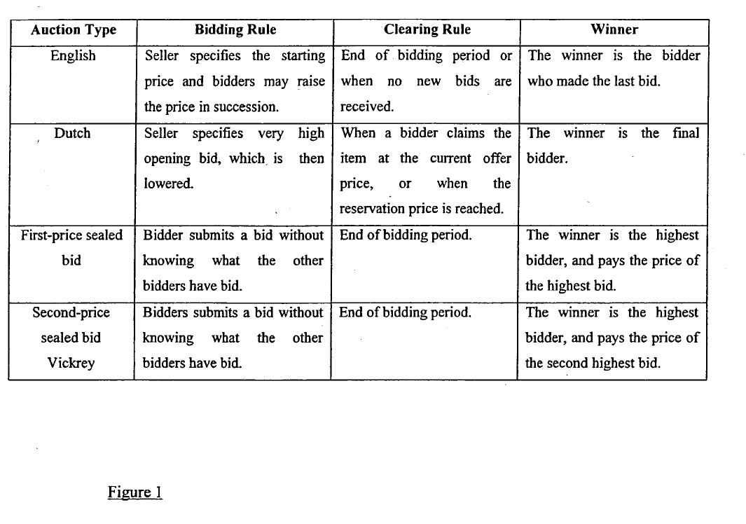

### DETAILED DESCRIPTION OF THE PREFERRED EMBODIMENTS

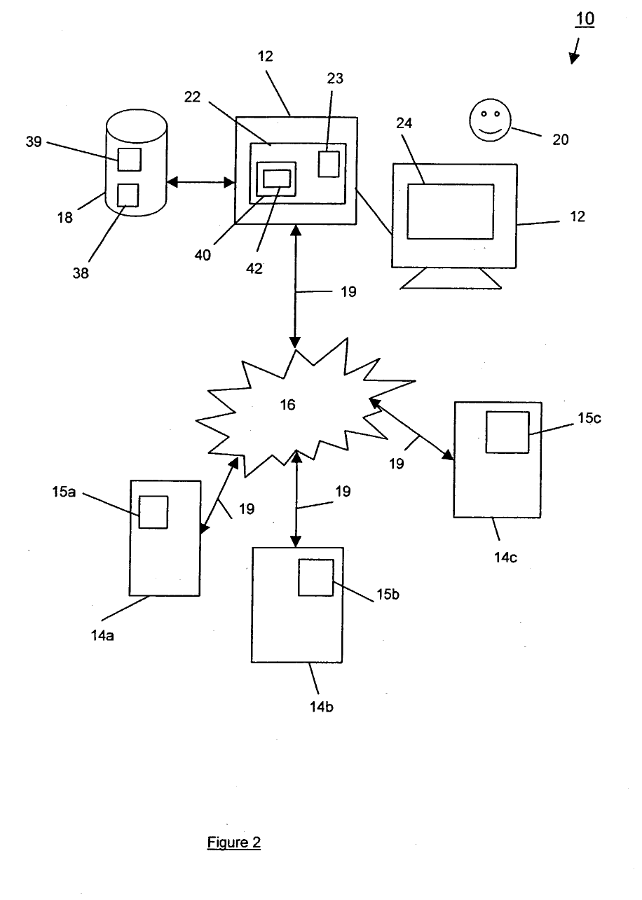

Referring to FIG. 2 there is shown a client-server system 10 which is suitable for implementing a presently preferred embodiment of the invention. The client-server system 10 comprises a client computer 12 which is connected to a plurality of server computers 14a, 14b, and 14c via the Internet 16. Server computer 14a hosts the auction Web site “www.itsadeal.com” 15a, server 14b the auction Web site “www.eBay.com” 15b, and server 14c the auction Web site “www.cheapaschips.com” 15c.

The client computer 12 is optionally connected to a database 18 by way of a farther connection. The database 18 stores data 38 (such as the closing price of an auction for a particular type of goods, and the type of auction) of previously held auctions, and probabilistic belief models 39. Double headed arrows 19 in the Figure indicate that data can be exchanged in both directions between the client computer 12 and the server computers 14a, 14b, and 14c, and between the client computer 12 and the database 18. At the client side of the system 10, there is provided agent software 22 which implements an agent 23 (hereinafter the terms agent software and agent are used interchangeably). The agent 23 has access to the Web sites 15a, 15b, 15c of electronic auctions hosted on server computers 14a, 14b and 14c via the Internet 16. In order to enable a user 20 to communicate with the agent 23, the client computer 12 has an agent interface 24 provided. The agent software 22 also implements algorithms 40 and 42, which will be described in detail later.

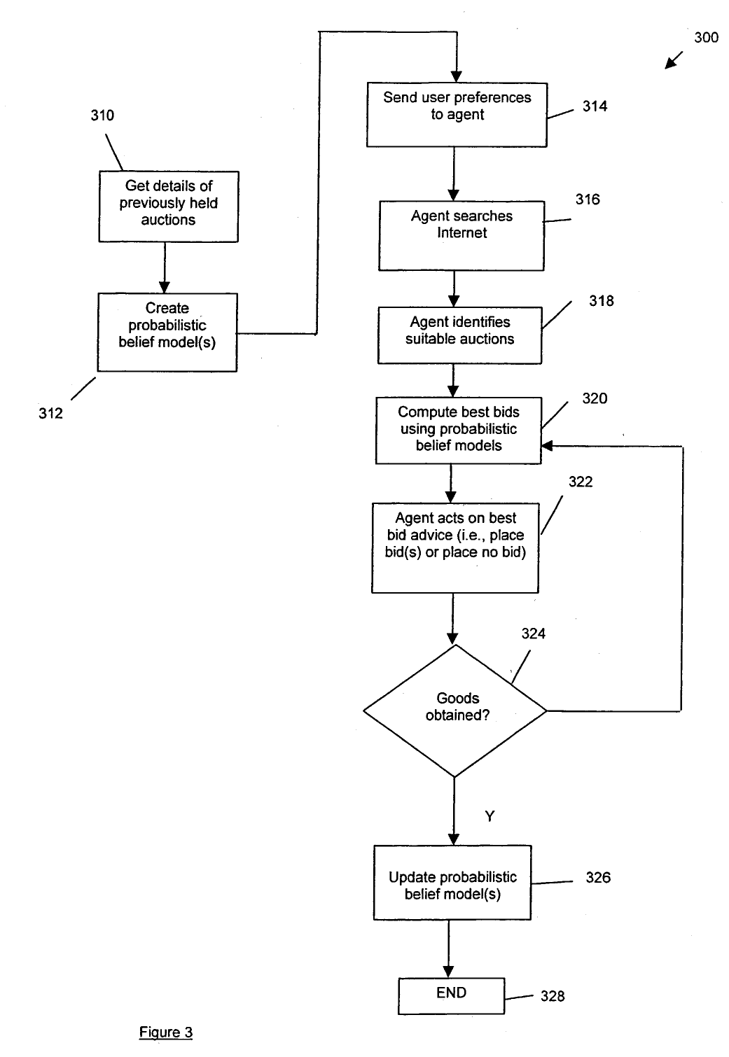

An overview of the method of the invention will first be described with reference to the flow diagram of FIG. 3, followed by a more detailed explanation of the individual method steps.

The method 300 commences with retrieving at Step 310 data 38 relating to previously held auctions for a particular good or type of good from the database 18. This data 38 is then used at Step 312 to create probabilistic belief (or likelihood) models 39 specifically for the type of goods that the user 20 wishes to purchase. The agent 23, with the use of these models and algorithms 40 and 42, has the ability to determine the likelihood of obtaining goods in specified auctions for a specified price. Method steps 310 and 312 may be carried out offline on the client side of the system 10, before the iterative portion of the method 300 begins.

The user 20 then sends to the agent 23 (at Step 314) details of the goods that he wishes to purchase. Upon receiving details of the preferences of the user 20, the agent 23 then trawls at Step 316 the Internet 16 and identifies at Step 318 suitable auctions in which it may want to place bids on behalf of the user. Once these suitable auctions have been identified at Step 318, the agent 23 computes at Step 320 an optimal set of bids using algorithms 40 and 42 and the probabilistic belief models 39 which have been determined in advance. The optimal set of bids identifies in which auctions the agent 23 should place bids and, for sealed-bids, how much the bid value should be. The agent then acts on the optimal set of bids advice, placing at Step 322 bids (where required) in the identified auctions.

After the bids have been placed, the agent 23 checks at Step 324 (after a predetermined time period) whether goods have been obtained which meet the user's requirements. If the user's requirements have not been met, then the optimal best bids are recomputed by repeating Step 320. Method steps 320 to 324 are repeated until either the user's requirements have been met, or some other criterion has been reached. If the user's requirements have been met, the agent stops bidding (Step 328) and details of the closing price of the auction are optionally used to update (at Step 326) the probabilistic belief models 39

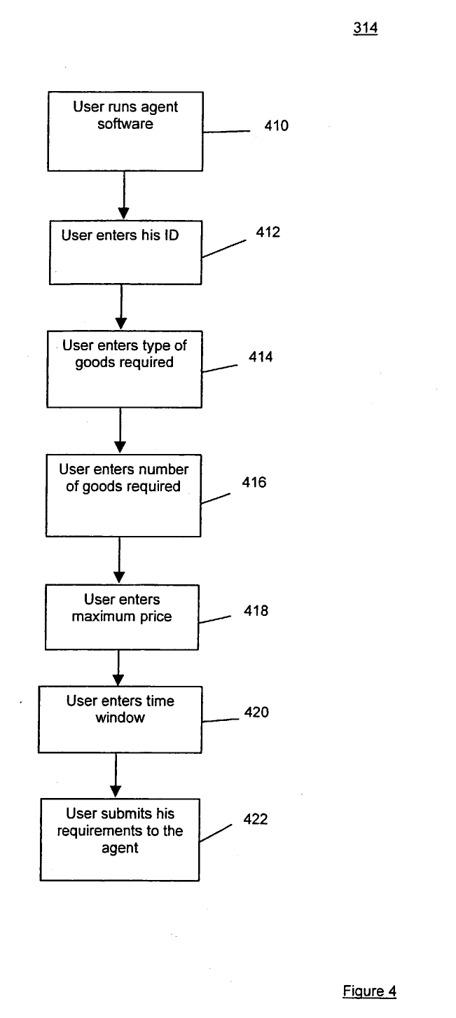

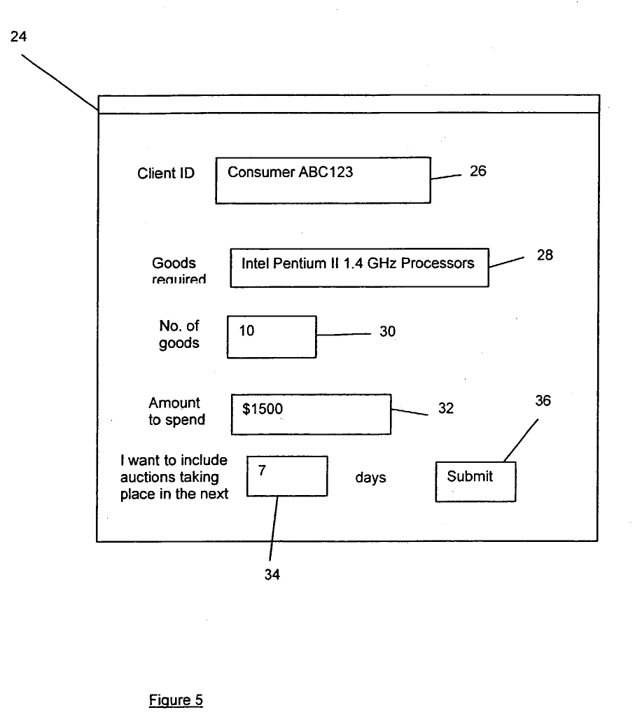

Now the individual method steps described above are set out in more detail, starting with Step 314 where the user's requirements are provided to the agent 23. Referring now to FIG. 4, the user 20 runs at Step 410 the agent software 22 on his client computer 12, thereby displaying the agent software interface 24 shown in FIG. 5. The user 20 then enters at Step 412 in text box 26 his ID which may be required to access some auction Web sites 15a, 15b, 15c. The type of goods required, the number of goods, and the maximum price that the user is willing to spend is then entered by the user at Steps 414, 416 and 418 in text boxes 28, 30, and 32, respectively. In this example, the user 20 works in the purchasing department of a company, and would like to buy 10 Intel® Pentium® II 1.4 GHz processors for $1500 in order to fulfil a purchase request in one week's time. As the user 20 needs to fulfil his purchase request by a set date, he enters at Step 420 (in text box 34) the time period of seven days so that all suitable auctions which are taking place within that time period will be considered by the agent 23. The user 20 then clicks at Step 422 on the submit button 36 to submit his requirements to the agent 23.

Returning to FIG. 3, during the trawling Step 316, the agent 23 connects to and searches the Internet 16 for auctions which are selling Intel® Pentium® II's and which are currently taking place and will close before the end of the seven day window, and/or will open in the future and close before the end of the seven day window. Searching for future auctions is possible as many auction Web sites advertise upcoming auctions in advance. In Step 318, the agent 23 identifies three potentially suitable on-line auctions: an English auction on “www.itsadeal.com” 15a, a Dutch auction on “www.eBay.com” 15b, and a scaled-bid auction on “www.cheapaschips.com” 15c which are (or which will be) auctioning Intel® Pentium® II's within the required time window Alternatively, instead of the agent 23 searching the Internet for auction Web sites, there may be provided an auction “portal” Web site hosted on a single server computer which serves as an access point to many different auction Web sites. In this case, the agent 23 would simply submit a search request to the auction portal Web site to find the required auctions so that it does rot have to search the Internet itself.

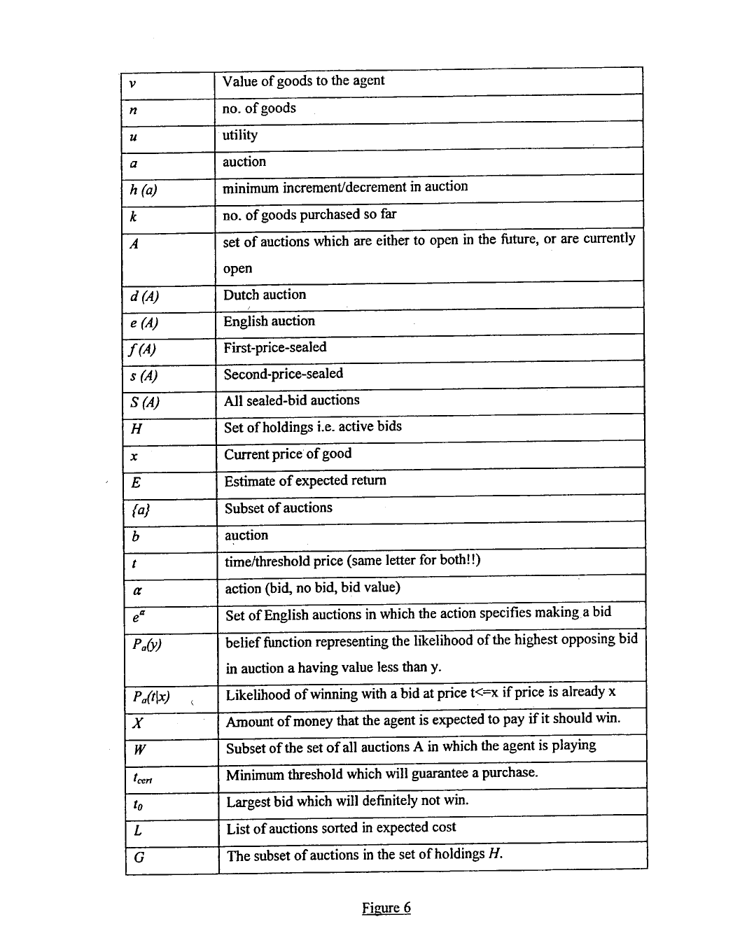

Step 320 of the method 300 (in which the set of best or optimal bids is computed) is the most complex part of the method: the background mathematical reasoning is therefore set out in detail below. Firstly, the notation used in the mathematical reasoning is presented, the variables being summarised in the glossary of FIG. 6.

Suppose that the agent 23 has the following beliefs about the possible outcomes of future events in a set of auctions. Firstly, it is supposed that auctions a are each for a single good (e.g., a single Intel® Pentium® II 1.4 GHz processor). Secondly, the value of n goods to the agent 23 in monetary terms is a fixed private constant (fixed means that the value depends on the number of goods bought and it is private because no-one else/no other agent knows the value) is defined as v(n) (which is normalised such that v(0)=0), giving the utility of obtaining n goods at total price x is u(n,x)=v(n)−x.

Protocols for the different types of auctions are also defined as follows. In an English auction a, each bid must be at least h(a) larger than the previous bid to be valid. For example, in an English auction the minimum amount the bid may be increased by could be $1,000 if, say, an Old Master was being auctioned, or as little as $1 for a second hand item of furniture. It is assumed that if the agent 23 bids, it will certainly obtain the “leading bid”, although it may subsequently be out-bid by another bidder.

In contrast to an English auction, the price in a Dutch auction a decreases continuously with time at h(a) monetary units per unit time. For example, the starting price when auctioning a second-hand car “worth” $500 may start at an optimistic $1,000, and be lowered in decrements of $50 until a bid is made. It is assumed that if the agent 23 chooses to bid, it will certainly obtain the good at its bid price. In first and second sealed bid auctions, the agent 23 wins if it has posted the highest bid, and pays either the value of that bid, or the value of the second highest bid, respectively.

The number of goods purchased by the agent 23 so far is referred to herein as k.

The following set notation is used herein.

Let x be an element or member of a set A. This is written x 0 A. Now let there be another set A If A is a subset of (i.e. contained in) B, this is denoted by A δ B. The union of A and B can also be defined, which is written A χ B. This means the set of all objects which are elements of A or of B, or of both A and B. Now define the intersection of A and B, denoted by A 1 B. This means the set of all objects which are in both A and B. Lastly, the relative complement A\B is defined, giving the set of all objects that belong to A but not to B.

A is now defined as the set of auctions which are either to open in the future, or are currently open. Subsets of A consisting of Dutch, English, first-price-sealed and second-price-sealed auctions are written d(A), e(A), f(A) and s(A), respectively. The set of all sealed-bid auctions is written S(A) (where S(A)=s(A) χf(A)).

It is assumed that the agent 23 is a “rational agent”, that is, one that behaves in a rational manner. A rational agent should choose to bid in a given auction if the expected return from the future, given that the agent actually bids, is greater than the expected return from the future given that the agent does not bid. This is in contrast to a human who is not considered rational. For example, a human given the choice between 1) receiving a guaranteed $50, and 2) receiving $100 if a tossed coin is heads, but nothing for tails, would be more inclined to accept the 550. A rational agent's behaviour, however, would differ from that of a human, because it would work out that the average likely outcome is $50 for both, and conclude that one choice is not better than the other. Included in the set of sealed-bid auctions S(A) are sealed-bid auctions whose deadline for submissions of bids has passed but which have not yet announced a winner. A rational agent would never submit a sealed-bid early. This is because the agent 23 must always speculate about fixture events in order to calculate the best bid value. However, speculation is always inferior to basing a decision on known facts. Only if delaying the submitting of a bid might alter the potential outcome of an auction (as in an English or a Dutch auction) can it be best to bid early. In the case of sealed-bid auctions, the timing of the bid does not affect the outcome of the auction, so it is better to wait until the last minute in order to base decisions on facts rather than guess-work. It therefore follows that for the purposes of making bidding decisions, it is only ever necessary to consider the set of sealed bid auctions whose submission deadlines are imminent, i.e. close enough so that the agent 23 does not expect to have another opportunity to submit a bid. Imminent bids are written S^{J}(A).

It is also necessary to define a set of holdings H, where H is a subset of A. An English auction is in the set of holdings H if the agent 23 holds the winning bid in that auction. In other words, the agent 23 has a holding in an English auction if he holds the current bid, but does not yet have the goods. A sealed-bid auction is in the set of holdings H if the agent 23 has submitted a bid to the auction, and the result has not yet been announced. It is not possible to hold a bid in a Dutch auction, since a bid instantaneously wins, and therefore Dutch auctions are not included in the set of holdings H.

A current price vector x is defined for each auction in the set of auctions A. For an English auction, the current price is the price of the bid that has just been placed. In the case of a Dutch auction, the price current price is the current posted bid. In the case of sealed-bid auctions, the current price is the price of the bid that the agent 23 has placed if it has bid. However, the current price for a sealed-bid auction is defined if the agent 23 has not yet bid.

The most significant challenge in producing a method of providing bidding advice in multiple auctions is that of estimating the expected return of future events, especially since this expected utility is inextricably bound up with the bidding choices that the agent 23 itself makes. A method for determining an estimate E of the expected return from playing in multiple auctions A given that the prices in these auctions are currently given by the vector x, that k goods have so far been purchased, and that the bids H are currently being held (i.e. E (k, A, H, x)) is therefore required. This will be addressed later in the description. However, it is useful first to consider the problem an agent faces when bidding in a single auction a. This case may then be generalised to deal with multiple auctions.

Consider the simple decision of whether or not to bid in a single English auction, a, from among the set of all suitable English auctions e(A) which are selling Intel® Pentium® II processors. If the agent 23 bids, it will become active at a slightly higher price than the price currently being bid, i.e., at x(a)+h(a). For example, if another agent has bid $100 for a chip, the agent 23 needs to bid at $100+$5 (if h=$5) to stand a chance of winning the good. If the agent 23 does not bid, it will therefore be inactive at the price x(a) i.e. at $100.

The choice to be made by the agent 23, therefore, is between the expected utility E (k, A, H, x) for not bidding, and the expected utility E (k, A, Hχ {a}, x) for bidding, where x′(b)=x(b)+h(b) if b =a, and x′(b)=x(b) otherwise, {a} is a single English auction and b is an English auction (i.e. x is the same as x except for the auction a under consideration). If the expected utility for bidding is larger than the expected utility for not bidding, then the agent 23 should bid. On the other hand, if the expected utility for not bidding is larger than the expected utility for bidding, then the agent 23 should not bid.

If the agent 23 is presented with a decision to bid in a single Dutch auction, the choice to be made is slightly different from an English auction. If the agent 23 bids, it will win immediately, as this is the nature of Dutch auctions, and the expected utility is E(k+1, A\{a}, H, x)−x(a). On the other hand, if the agent 23 does not bid, then some small amount of time *t must inevitably elapse before the decision to bid or not to bid is undertaken again. This is unlike the English case, where the leading bid may be the same for large periods of time. Thus, in a Dutch auction, the choice not to bid must cause the price to go down, such that the expected utility may be defined as E(k, A, H, x′) where x′(b)=x(b)−*th(b) if b 0 d(A), and x′(b)=x (b) otherwise, and {a} is the subset of Dutch auctions.

Here, the price x is assumed to be a continuous function of time: there is no “step” in price, just a smooth decrease in price as time goes on. The variable h(b) in this case is the rate of its decrease. In this case, it is assumed that the period of time *t is small enough that the non-Dutch auctions have negligibly small probability of changing in price over the specified time interval.

For sealed bid auctions, the choice to be made is not whether to bid or not, but how much to bid. If the agent 23 chooses to bid nothing, i.e. not to bid, then it should expect utility E(k, A\{a}, H, x) If the agent 23 chooses to bid at price X, then the expected utility is E(k, A, Hχ {a}, x′) where x′(b)=X if b=a, and x′(b)=x(b) otherwise, and {a} is the subset of sealed-bid auctions.

Notwithstanding the above, at a given moment in time, the agent 23 will in fact be confronted with a far more complicated decision problem due to the fact that bidding choices in different auctions are far from independent, and so should therefore be considered together.

When playing in auctions A, with holdings H, the agent 23 may bid in any of the English auctions in which it does not hold the active bid, and in any Dutch auction. It can only choose to bid in a sealed bid auction in S(A)H (i.e. sealed-bid auctions in which a bid has not been submitted) and, as previously explained, should only bid in S^{J}(A)\H. (i.e. an auction which is imminent).

Now, let ∀be an action which assigns a choice of “bid or “no bid” to each continuous (e.g. English or Dutch) auction, and either “no bid” or a bid value to each sealed bid auction. It can then be written e^{∀}, d^{∀} and S^{∀} for the set of English, Dutch and sealed-bid auctions respectively in which the action specifies making a bid.

From an action ∀ the agent 23 can expect utility:

$$E ( k + \vert {d}^{∀} \vert , A \backslash ( {d}^{∀} χ ( {S}^{I} ( A ) \backslash {S}^{∀} ) ) , H χ {S}^{∀} χ {e}^{∀} , {x}^{∀} ) - {\sum }_{a ∈ d ( A )} x ( a ) \qquad ( 1 )$$

where the price function x^{∀}(b) is defined for b 0 A(d^{\}χ(S^{J}(A)S^{∀})) (i.e, auctions in the set of auctions A which are not in d^{∀} and/or not in the set of sealed-bid auctions in which a bid is not specified) by: x(b)−*th(b) if b 0 d(A) (i.e. if b is a Dutch auction); x(b) t h(b) if b 0 e^{∀} (if a bid in an English auction is specified); ∀(b) if b 0 S^{∀}(i.e. V(b) is the price of the sealed-bid submitted in a sealed-bid auction); and x(b) otherwise.

Equation (I) implicitly provides a specification of the algorithm used by the agent 23 to choose whether or not to make a bid in a particular auction: whichever action ∀ maximises this equation is the action that the agent 23 should take. Providing an algorithm for the agent 23 is then a matter of choosing a suitable mechanism for approximating the underlying expected utilities, and providing an algorithm for the discovery of the maximising ∀ (i.e. for bidding, not bidding, or providing a bid value). Computing the exact value of the expected utility from optimal behaviour is possible in some circumstances, but generally impossible. Generally, the best one can hope to do is to provide estimates.

The expected utility E that can be extracted from a set of auctions can be estimated by considering a set of possible future strategies, and choosing the best among them. Because the set of strategies is not exhaustive, this estimate will be less than or equal to the actual expected utility of future auctions, and hence a pessimistic estimate. One particularly simple set of strategies, the fixed-auction strategies, consist of choosing a set of auctions in the future, and committing to buy from them to obtain goods which meet the user's 20 requirements by placing whatever bid or bids are required to guarantee a successful purchase.

Assuming the agent 23 holds no active bids, the best fixed-auction strategy is straightforward to calculate: the best fixed-auction strategy buying from n auctions will simply be the strategy which purchases from the n auctions with the lowest expected prices. The best fixed-auction strategy can be found by selecting which of these n auctions maximises the expected utility. If, however, the agent 23 holds some existing active bids in English or sealed bid auctions, the problem becomes more complex. The fixed-auction strategy which gives the best expected utility E at this point in time may involve choosing a set of auctions which does not include some or all of these active bids. Because of this, the agent 23 must consider the expected utility of this strategy. In such a strategy, the agent 23 effectively ignores the active bids in auctions outside the chosen auction set, in the expectation that they will be outbid. However, there is a risk associated with this: there is a certain probability the agent will not be outbid, and so will make an accidental purchase in one of these auctions. The cost and benefit of this outcome must be factored in

If the agent 23 uses such estimate of expected utility together with the decision procedure described previously (i.e. whichever action maximises Equation (1)), then it effectively chooses to follow the best fixed-auction strategy available at any given time. This may involve switching to a new auction set as circumstances change, possibly leaving active bids in the original auctions. Provided the net cost of the risk associated with these is outweighed by the expected benefit of switching to a better auction, the agent 23 will make the switch.

Generalising this notion, the set of all fixed threshold strategies may be considered. A fixed threshold strategy consists of assigning a threshold t to every auction, which entails an a priori commitment that depends on the auction protocol. For English auctions the agent 23 commits to bid up to t, then drop out if unsuccessful (hence the name “threshold”) For Dutch auctions the agent 23 commits to bid at price t, if it ever gets that low. For sealed-bid auctions the agent commits to bid t. Clearly, fixed-auction strategies are the special case where some auctions are assigned thresholds guaranteeing a successful purchase, while others are assigned zero thresholds. Calculating the best fixed-threshold strategy is more complex than the fixed-auction case, but still significantly easier than exhaustive backwards induction. Later on in the description, the fixed-auction strategy and the fixed-Threshold strategy will be defined, and an algorithm for calculating the best fixed-auction strategy will be provided.

It is interesting to note that the fixed-auction and fixed-threshold strategies use no information on the ordering of future auctions (i.e. the time at which future auctions start). This means that the approach of using either the fixed-auction strategy or fixed-threshold strategy as an estimate of future utility is generally applicable, and can be used even if the ordering is unknown beforehand. However, an estimate of future utility which assumes a strategy capable of exploiting any known order would be closer to the actual expected utility (note that the previously described strategy for providing the expected utility for multiple auctions does exploit the order of auctions—it is merely the estimate used by the strategy which does not, and hence will be lower than the true expected return).

Fixed-Threshold Strategies

The fixed-threshold strategy referred to above is now examined in detail to obtain estimates of future utility. A formula E, (k, A, H, x) for the expected return on using the fixed threshold strategy with the vector of thresholds t is now derived. There are two restrictions on the space of valid thresholds, which both amount to saying that one cannot commit to the impossible. In an English auction, the threshold must be greater than or equal to the current price, and in a Dutch auction, it must be less than or equal to the current price. E [symbol] provides an estimate of the maximal value that can be obtained from the future as

$$E ( k , A , H , x ) ≅ {max}_{valid t} {E}_{1} ( k , A , H , x )$$

This is the estimate of future utility upon which the agent's bidding algorithm of the present invention is based. To begin with, the case where the agent 23 is confronted with a single auction A=(a) is considered.

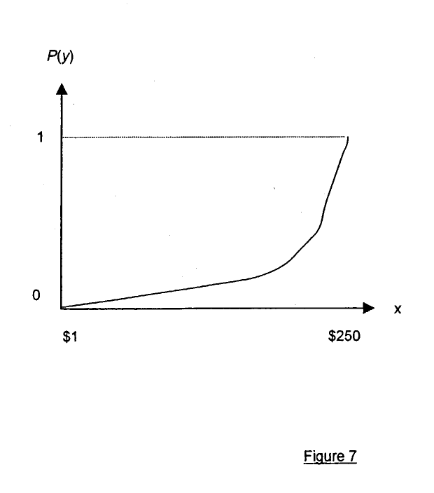

The probability of obtaining the good is determined using a belief function Pₐ(y) representing the likelihood of the highest opposing bid in auction a having a value less than y. In all cases, the probability of winning is precisely the probability of the highest opposing bid being less than t. An example of a belief function P for all English auctions for Intel Pentium II 1.4 GHz processors on the Web site “www.cheapaschips.com” is shown in FIG. 7. This function P illustrates that the probability of winning a processor at the price of $1 is zero, and the probability of winning a processor for $250 is one. That is, the agent 23 will certainly not win the processor if its bids a value of $1 in the “cheapaschips” auction, but is certain to win the processor if it bids $250 as his is way above the current market price of the good. The probability of winning if the agent 23 bids a price between $1 and $250 may simply be read from the graph

If the auction is sealed-bid, then there is only the a priori probability distribution to go on, and so the probability of a bid of t winning is Pₐ(t). This function is built up from observation of the winning bids in similar auctions that have taken place in the past (see Steps 310 and 312) For example, if N sealed-bid auctions have been observed (whether by the agent 23 or another observer), of which n had winning bids less than t, then n/N is a suitable estimate of Pₐ(t).

If the auction is continuous (i.e. English or Dutch), this probability distribution (or belief function) must take into consideration the current price. This is easily done in the Dutch case. If the price is currently x, then the likelihood of winning with a bid at price t≦x is Pₐ(t|x)=Pₐ(t)/Pₐ(X).

In the English case, care must be taken to consider whether the agent 23 holds the active bid or not. That is, whether a 0 H. If a is a member of H and therefore holds the winning bid, then the highest opposing bid must be greater than or equal to x−h where h is the bid increment in auction a. Otherwise, if the agent 23 does not hold the winning bid, it's bid must be greater than or equal to x. This gives rise to two possibilities (once again there is a threshold restriction, t≧x this time): Pₐ(t|x)=Pₐ(t)−Pₐ(x−h)/(1|Pₐ(x−h)) if the agent 23 holds the active bid. Else, Pₐ(t|x)=Pₐ(t)−Pₐ(x)/(1−Pₐ(x)) if the agent 23 does not hold the active bid.

It can be defined, for the sealed bid case, Pₐ(t|x)=Pₐ(x) if the agent 23 holds the active bid, else Pₐ(t|k)=Pₐ(t) if the agent 23 does not hold the active bid. Pₐ(t|x) thus specifies the likelihood of the fixed threshold strategy t resulting in a purchase, given that the current price is x. The current price x of a sealed bid auction is not defined if the agent 23 has not yet bid. If the agent 23 has bid in auction a, then the current price x is meant to mean the value of the bid which has already been placed, as discussed previously.

Now the cost of winning in an auction will be addressed. The amount of money that the agent 23 is expected to pay if it should win is denoted Xₐ(t|x), and depends on current price x just as the probability does. For first-price auctions (i.e. first-price sealed bid and Dutch auctions), if the agent 23 wins, it will pay its bid price t such that Xₐ(t|x)=t.

For second-price sealed-bid auctions, if the agent 23 wins, it will pay the highest opposing bid. The expected costs of winning the good in that one auction are evaluated by summing over all possible prices x′ the cost x′ multiplied by the likelihood that x′ will be the price paid. As continuous probability distributions are used this sum is an integral, and the infinitesimal probability of the highest opposing bid being x′ becomes the differential dPₐ(x′). For second-price sealed-bid auctions, this gives the cost estimate

$${X}_{a} ( t \vert x ) = {\int }_{o}^{t} {x}^{′} ⅆ {P}_{a} ( {x}^{′} ) .$$

English auctions, however, present two further difficulties. The highest opposing bid is bounded below, as before, which requires conditioning of the probabilities involved. This means that, as soon as the auction is under way, there is information about the highest opposing bid—it can be no lower than the current price (−h, depending on whose bid is the highest) Thus, the a priori estimates of how likely it is for the highest opposing bid to take each value must be adjusted in line with this new information. The differential dPₐ(x′) becomes, in the case of a being a member of H, dPₐ(x′|x)=dPₐ(x)/(1−Pₐ(x−h)), and likewise where a is not a member of H. Again, there are slightly different cases depending on whether the bid at x is held by the agent 23 or not:

$$\begin{matrix}{X}_{a} ( t \vert x ) = {\int }_{x - h}^{t} {x}^{′} ⅆ {P}_{a} ( {x}^{′} \vert x ) , if the bid is held by the agent 23 ; and \\ {X}_{a} ( t \vert x ) = {\int }_{x}^{t} {x}^{′} ⅆ {P}_{a} ( {x}^{′} \vert x ) , if the bid is not held by the agent 23. \end{matrix}$$

An expression for Xₐ(t|x) is therefore provided for all auction types.

A formula for the expected return on using a fixed threshold t may now be derived. If the agent 23 does not win the good, it gets nothing. If it wins the good, which happens with probability Pₐ(z|x), then the utility is the value of the good, v(1), less the expected value of the price of the costs, given the good is purchased Xₐ(t|k) which gives: E [symbol] (a, x)=Pₐ(t|x)(v(1)−Xₐ(t|x)). The above may now be generalised to the multiple auction case. Consider the expected utility E [symbol] (k, A, H, x) of using the fixed threshold strategy t, which assigns threshold t(a) to each auction a in A. Now let W be any subset of the set of all auctions A in which the agent 23 is playing (i.e. bidding up to or at specified thresholds). The probability P_{A}(W, t|x) of winning all the auctions in W and losing all the auctions in A\W when using the fixed thresholds t is the product over all auctions of the probability of the corresponding outcome in that auction:

$${P}_{A} ( W , t \vert x ) = {\prod }_{a ∈ W}^{} {P}_{a} ( t ( a ) \vert x ( a ) ) {\prod }_{a ∈ A \backslash W}^{} ( 1 - {P}_{a} ( t ( a ) \vert x ( a ) ) ) .$$

If the agent 23 wins exactly the auctions W, its immediate utility is v(|W|+k), and its costs (i.e. total amount of money spent) have expected value equal to the sum of the expected expenses in each auction:

$${X}_{W} ( t \vert w ) = {\sum }_{a ∈ W}^{} {X}_{A} ( t ( a ) \vert x ( a ) ) .$$

It follows that the agent 23 should expect utility

$${E}_{t} ( k , A , H , x ) = {\sum }_{W ⋐ A} {P}_{A} ( W , t \vert x ) ( v \vert W \vert + k ) - {X}_{W} ( t \vert x ) \qquad ( 2 )$$

from using the fixed threshold strategy t. A rational risk-neutral agent wishing to choose a fixed-threshold strategy should use the threshold vector t maximising Equation (2). Notice that if the threshold to be used is re-evaluated later, the optimal choice of thresholds may well be different.

Fixed-Auction Strategies

The fixed-auction strategies may now be given a formal definition as a special case of fixed-threshold strategies. For a given auction, a 0 A, the certain purchase threshold t_{cert}(a) is defined as the minimum threshold which will guarantee a purchase in auction a; t_{cert}(a)=min {x|Pₐ(x)=1). For any subset WδA, the corresponding fixed-auction strategy t_{cert}(FP is the fixed threshold strategy which assigns thresholds of t_{cert}(a) to each auction in W, thresholds of x(a) to each auction in e(A)W (that is, English auctions to be dropped) and in W 1 d(X) (Dutch auctions to be bid in immediately), and thresholds of 0 to all other auctions in A.

Note that for a given probability distribution of expected highest opposing bids, the expected cost of guaranteeing a purchase in an English or Vickrey auctions will be significantly less than the expected cost of a Dutch or First-price sealed-bid auction. This is because the only way to guarantee a purchase in a first-price auction is to bid very high, and a high bid has to be paid in a first-price auction, whereas in a second-price auction only the second-highest price has to be paid. For that reason, fixed-auction strategies will favour the former auctions over the latter.

In the case of fixed-auction strategies Equation (2) becomes:

$$\begin{matrix}{E}_{cert} ( W ) ( k , A , H , x ) = ( v \vert W \vert + k ) - {X}_{W} ( {t}_{cert} \vert x ) + \\ {\sum }_{S ⋐ H \backslash W} {p}_{H \backslash W} ( S , x \vert x ) ( v \vert W + S \vert + k ) - \\ ( v \vert W \vert + k ) ) - \\ {\sum }_{a ∈ H \backslash W} {X}_{a} ( x ( a ) \vert x ( a ) ) {P}_{a} ( x ( a ) \vert x ( a ) )\end{matrix} \qquad ( 3 )$$

The Decision Making Algorithm

It is required that the expression given in Equation (1) be maximised with respect to the action-set variable ∀ in order to determine the best bids the agent 23 should make. This expression requires a faction to estimate the expected future utility to the agent 23 of any given state in the set of auctions.

Various ways of maximising Equation (1) with respect to the set of actions ∀ are possible. For example, it could be used as a fitness function for a genetic algorithm. However, simple optimisation algorithms such as hill-climbing are unlikely to yield good results, as Equation (1) is highly discontinuous with respect to the action set ∀—a change in one parameter (such as bid/no bid in a given auction) will have a large impact on the desirability of a given value of another parameter. In general, the number of auctions running simultaneously and auctioning a similar good will be relatively small, of the order 1 to 10 in the business to business world, and 10 to 100 in the consumer world. Hence, the number of possible action sets ∀ will also be relatively small. For that reason, it is likely that in most cases the computational overhead of a genetic algorithm would be counterproductive, and a simple brute-force search of the space would be more efficient. The following algorithm which is utilised in the present invention carries out a brute-force search of the space, and it also exploits certain heuristic properties of auctions to prune (i.e. remove) areas of the space which are a priori unlikely to yield good solutions. The properties used by the algorithm are:

1. If a₁,a₂ 0 d(A) are Dutch auctions, x(a₁)≧x(a₂) and Pₐ₁(x(a₁)|x(a₁))≦Pₐ₂(x(a₂)|x(a₂)) (where at least one of these is not equal), then the agent 23 should bid in auction a₂ in preference to auction a.

For example, if there are two Dutch auctions D1 and D2, and the likelihood of wing the good in auction D1 given the bid price of $20 is 0.7, and the likelihood of winning the good in auction D2 given the bid price of $10 is 0.9 then, according to the above property Dutch auction D2 is preferred to Dutch auction D1. It is clearly seen that by bidding in the Dutch auction D2 which is cheaper and more likely to close, a better price is achieved an a better set of options in the future is gained (this property is clearly always true). However, if the likelihood of winning the good in auction D1 is 0.8, and the likelihood of winning the good in auction D2 is 0.75, property one does not hold and neither auction is preferred.

2. If a₁,a₂ 0 e(A) are English auctions, x(a₁)≧x(a₂) and Pₐ₁(x(a₁)|x(a₁))≦Pₐ₂(x(a₂)|x(a₂)) (where at least one of these is not equal), then the agent 23 should bid in auction a, in preference to a.

Consider two English auctions E1 and E2 which have likelihoods of closing below a certain price, of 0.5 and 0.6 respectively, and where the current price x (i.e. the price of the current bid) in auction E1 is $600, and the current price x in auction E2 is $400. Plugging these values into property number two gives the result that the agent should bid in auction E2 in preference to auction E1. In other words, by bidding in the English auction where the goods are cheaper and more likely to close at that price, the agent 23 holds a better position for the future (i.e. the bidder is more likely to obtain goods from the auctions which meet the user's requirements).

3. If a₁,a₂ 0 S_{J}(A) are sealed-bid auctions whose submission deadlines are imminent, and b₁,b₂ are potential bid values, the agent 23 should bid value b₂ in auction a.2 in preference to bid value b₁ in auction a₁ if Pₐ₂(b₂)≧Pₐ₁(b₂) and Xₐ₁(b₁)≧Xₐ₂(b₂) (where at least one of these is not equal).

For instance, let there be two imminent sealed-bid auctions S1 and S2, and the agent 23 is considering two potential bid values: one of $200 (bid one), and the other of $100 (bid two). The amount of money that the agent 23 is expected to pay if it should win in S1 with bid one is $300, and the amount of money that the agent 23 is expected to pay if it wins in S2 with bid two is $200. Again, by plugging these values into property three it is seen that the agent should bid $100 in auction S2. That is, it is preferred to place a bid which has both greater probability of winning and lower expected cost if the bid does win.

4. The maximum useful bid in a sealed bid auction a is t.,(a). Similarly, a minimum bid may be defined t₀(a) to be the largest bid which will definitely not win where; t₀(a)=max{x|Pₐ(x)=0}.

Unlike the first property, the second and third properties do not hold in all cases. This is due to timing issues. For example, in the case of sealed-bid auctions, it may be better to put a bid in a poorer auction (i.e. one that is likely to be more expensive, hence less preferred) because the better auction's results will not be revealed for a significantly longer time, causing the agent 23 to operate with more uncertainty in the intervening period. Hence, properties two and three are heuristic properties.

Property two can only be used if it is assumed that bids arrive in English auctions according to roughly the same rate distribution. Property three requires the assumption that the time between the deadline for bid submission and announcement of the winner of sealed auctions is roughly constant. The fourth proper is straightforward, but can only be used if the belief frictions are accurate.

The algorithm for generating the set of optimal bids will now be given. Firstly, the procedures required to implement the above properties one to four will be specified, and then the top-level algorithm utilised in the present invention will be presented.

To implement property one, a function dutchPrefer(a,b) is used. This function returns “true” if Dutch auction a is preferred to Dutch auction b according to property one, and “false” otherwise. Similarly, the friction englishPrefer(a,b) implements property two.

Now validSubsets(B, is defined as a function which takes a set of auctions B and a comparator function f of arity 2 as input. For example, if the set of auctions B comprises auctions p, q and r, vnlidSubsets(B,f) compares the auctions pairwise such that p is compared with q, p is compared with r, and q is compared with r. The definition of validSubsets is the set of all sets W contained in B, such that if auction a is in W, and if auction b satisfies f(b,a) (i.e. true is returned and auction b is preferred to auction a), then b must be in W.

Now define allSealedBidSets(S,h) to be a function which returns the set of sets of bids in the sealed bid auctions, S. The function allSealedBidSets achieves this by generating all possible sets of sealed-bids, with each auction either being assigned no bid, or a bid in the range t₀(a) and t_{cert}(a) in steps of h. So, for example, if t₀(a)=$50 and t_{cert}(a) is $100, and h is $10, the set of possible bids generated by this function would be: $50, $60, $70, $80, $90 and $100. The function allSealedidSets(S,h) then prunes this set of all sealed-bids, deleting any sets which do not satisfy heuristic property number three.

A further function actionUtility(∀,k,A,H,x) is now defined. This function implements Equation (1) using the function utilityEstimate(k,A,H,x) as follows:

$$\begin{matrix}actionUtility ( ∀ , k , A , H , x ) := utilityEstimate ( k + \vert {d}^{∀} \vert , \\ A \backslash ( {d}^{∀} χ ( {S}^{I} ( A ) \backslash {S}^{∀} ) ) , \\ H χ {S}^{∀} χ {e}^{∀} , {x}^{∀} ) {\sum }_{a ∈ d ( A )} x ( a )\end{matrix} \qquad ( 4 )$$

Given the functions dutchPrefer, englishprefer, validsubsets, allSealedidSets and actionUtility, the top-level algorithm 40 shown in FIG. 5a is defined This algorithm iteratively generates all subsets of the current (and all future auctions included in the time widow) Dutch auctions, pruning (i.e. removing) those which are dominated according to heuristic property 1. It then appends to the remaining Dutch auctions each subset of the current English auctions, which are pruned according to heuristic property 2. The subsets of English and Dutch auctions represent the auctions that the agent is currently considering placing bids in. Finally, the algorithm 40 appends each possible combination of bids in current sealed bid auctions, generated and pruned using heuristic properties 3 and 4. The algorithm 40 then tests the union of all three sets of pruned auction sets of bids (i.e. Dutch, English and sealed bids) to determine the estimated utility of this course of action. If the utility is greater than any previous set of actions considered, the algorithm 40 then stores this utility value as the current best utility value. The algorithm then continues through all the possible combinations of subsets of Dutch, English and sealed bid auctions, and returns the action set with the highest expected utility.

The top-level algorithm 40 may be illustrated by the following example In order to illustrate the operation of the validSubsets function, suppose there are two Dutch auctions so that d(A)={D1, D2}, with D2 preferred to D1, and two English auctions e(A)=(E1, E2} neither of which is preferred to the other. Now, it is required to work out validSubsets(d(A),dutchPrefer) and validSubsets (e(A),englishPrefer). Considering the Dutch auctions first, the set of all possible candidates in W is {{ },{D1},{D2},{D1,D2}}. The function dutchPrefer is a “constraint” on the members of W, which says that if D1 is a member of W, then W also has to include D2 W={D1} is eliminated as it contains D1 but not D2, and D2 is preferred to D1. Of course, the empty set { } is always a possible subset of W (i.e. no Dutch auctions at all will be considered). Thus, the validSubsets of Dutch auctions are {{ }, {D2},{D1,D2}}.

Now validSubsets(e(A), englishPrefer)) is considered. This is easier to determine as there are no englishPrefer constraints. That is, E1 is not preferred to E2, and E2 is not preferred to E1, according to property two. ValidSubsets(e(A), englishPrefer)) is therefore the set of all subsets of e(X), namely {{ }, {E1}, {E2}, {E1,E2}}.

Next, the set of all possible sealed bids is generated by the function allSealedBidSets Let h=1, and S(A)=S1, so that allSealedidSets(S(A), h) gives {0, 1, 2 . . . . , maxid}.

The algorithm 40 iterates through all combinations of the above three sets, calculating the estimate of the future utility of each combination. So, in this example, the first iteration of algorithm 40 determines the actionUtility for V{{ },{ },0}. That is, no bid in any Dutch or English auction, and a bid value of zero (i e, no bid) in sealed-bid auction S1. ActionUtility is then calculated for each set of sealed-bids such that ∀={{ }, { }, {0 . . . maxBid}}. Once the innermost loop has been iterated through, the loop for the set of English auctions is iterated i.e., where ∀={{ },{{ },{E1},{E2},{E1,E2}},{0 . . . maxBid}}. Finally, the effect of bidding in the set of Dutch auctions is determined such that ∀{{{ },{D2},{D1,D2}},{{ },{E1},{E2},{E1,E2}},{0 . . . maxbid}}. The last such iteration (where ∀={{D1,D2},){E1,E2}, {maxBid}}) calculates the effect of bidding in both Dutch auctions D1 and D2, both English auctions E1 and E2, and placing the maximum bid in sealed-auction S1.

Having defined the top-level decision making algorithm 40, it is now necessary to define another algorithm 42 to determine the utility estimate the decision making algorithm 40 will use. One embodiment uses an algorithm to calculate the best fixed-threshold strategy which uses a brute-force search of the possibilities, pruned using heuristics similar to heuristic properties 3 and 4 described previously. Such a brute-force search requires a search of O(b^{A}) possibilities (where A is the number of future auctions and b is the number of possible different bids in each auction) every time a utility estimate is required.

Another, preferred, embodiment utilises an algorithm which makes estimates using the best fixed-auction strategy. Although the best fixed-threshold strategy is more accurate than the best fixed-auction strategy, it is considered not to be worth the additional computation, and so the use of the fixed auction estimate is favoured. The best fixed-auction strategy is therefore presented in more detail below.

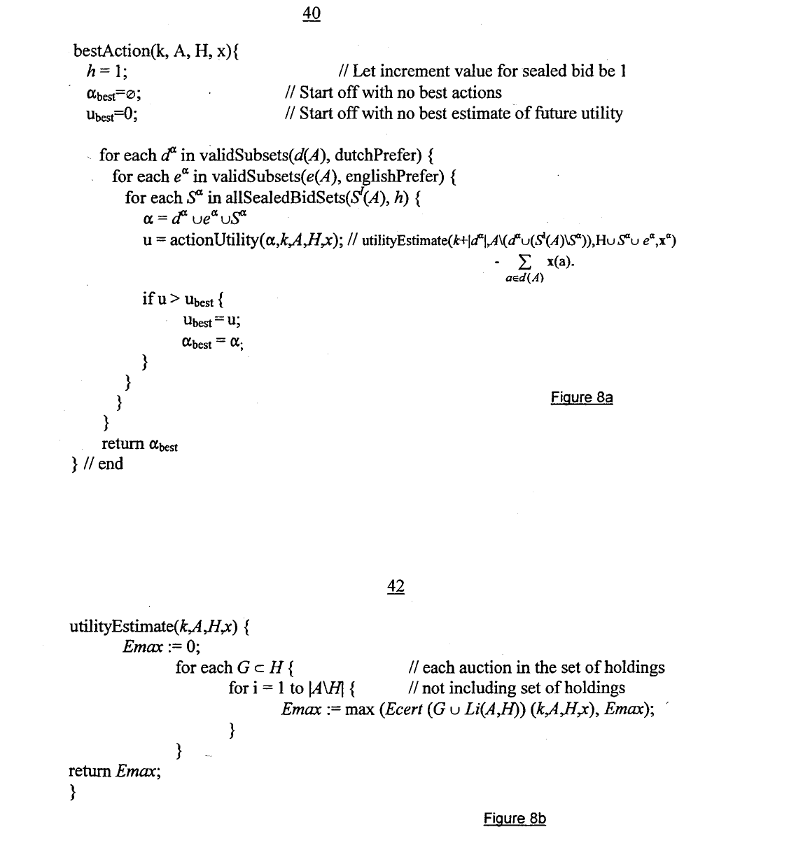

The algorithm 42 shown in FIG. 8b assigns the expected utility of the best fixed-auction strategy to the variable Eₘₐₓ. The terms used in this algorithm are now explained. First, let L(A,H) be the list containing the auctions A\H (i.e. the set of all auctions not including the set of holdings) sorted in order of expected cost when using the certain purchase threshold t_{cert}(a). That is, the cheapest expected outcome is at the top of the list, and the most expensive at the bottom of the list This is because the user 20 wants to acquire the goods at the cheapest possible price.

Now let Lᵢ(A,H) be a function returning the set consisting of the first i elements of L. Note that by ordering the auctions A\H, the algorithm 42 avoids the need for checking the expected utility of fixed-auction strategies which are a priori dominated by others (i.e. of higher expected cost than some alternative auction). Any subset of A\H of size i will have an expected cost at least as great as that of L(i), and thus substituting a subset of A\H of size ‘i’ for L(i) will not change the expected utility. This is because the consumer will get the same number of goods (and hence the same expected utility) but he will pay more for the goods, because L(i) is the cheapest i auctions. Unfortunately, the same trick cannot be applied to the set H without placing restrictions on the nature of the valuation function v.

As discussed previously, auctions in H which are not selected by a fixed-auction strategy have a chance of accidentally making an extra purchase, if they are not outbid. The probability, cost and benefit of purchasing unwanted goods must be factored into the algorithm. Different members of H have different such probabilities associated with them, and without restricting v, it is not possible to tell a priori whether these accidental purchases will increase or decrease the expected utility.

Consider now the same example described above, wherein the agent 23 has a holding in English auction E1 (remember that it is not possible to hold a bid in a Dutch auction, since making a bid wins the auction). No goods have yet been bought, so that k=0, and auction S1 is imminent. Now let ∀={{ },D1,5}, that is, compute the outcome of the agent 23 making a bid in the Dutch auction D1 (and therefore one immediate purchase), and making a bid of 35 in sealed-bid auction S1 (i.e. one transfer to the set of holdings B).

The function ‘utilityEstimate’ is then evaluated for k−1 (one good bought, namely D1), H={E1, S1}and A={D2, E1, E2, S1} (S1 can no longer be bid in, but as the analysis is not yet completed, it is retained). That is, it is required to calculate utilityEstimate(1,{D2, E1, E2, S1},{E1,S1},(x,5)) (where x is the price of the bid held in the English auction). Consider the estimation method for a fixed-auction strategy defined by the algorithm (42) This algorithm iterates through every subset G of H={E1,S1} of which there are four: { }, {E1), {S1}, {E1,S1}, where the set G is a possible set of auctions to commit to are currently held. A\H is the set {D2,E2}. These are then ranked in order of price. For example, suppose that the expected price of buying from D2 is less than the expected price of buying from E2. This gives L₀=0}, L₁={D2} and L₂={D2,E2}. The function utilityEstimate then finds the largest of the following estimating utilities:

E_{cert}({ })(1,{D2, E1, E2, S1},{E1,S1},(600, 5));

E_{cert}({E1})(1,{D2, E1, E2, S1},{E1,S1},(600, 5));

E_{cert}({S1})(1,{D2, E1, E2, S1},{E1,S1},(600, 5));

E_{cert}({E1, S1})(1,{D2, E1, E2, S1},{E1,S1},(600, 5));

E_{cert}({D2})(1{D2, E1, E2, S1},{E1,S1},(600, 5));

E_{cert}({D2,E1})(1,{D2, E1, E2, S1},{E1,S1},(600, 5));

E_{cert}({D2,S1})(1,{D2, E1, E2, S1},{E1,S1},(600,5));

E_{cert}({D2,E1,S1})(1,{D2, E1, E2, S1},{E1,S1},(600, 5));

E_{cert}({D2,E2})(1,{D2, E1, E2, S1},{E1,S1},(600, S));

E_{cert}({D2,E1,E23})(1, {D2 E1, E2, S1}, {E1,S1},(600, 5));

E_{cert}({D2,E2,S1})(1,{D2, E1, E2, S1},{E1,S1},(600, 5)); and

E_{cert}({D2,E1, E2,S1})(1,{D2, E1, E2, S1},{E1,S1},(600, 5));

E_{cert} being defined by Equation (3).

Returning to FIG. 3 and Step 320 of the method, in order to compute the set of best or optimal bids, the algorithms 40 and 42 are run as part of the agent software 22. As a result of this, the agent 23 has been given the bidding advice that, for this point in time, the best bids are to be placed in the following auctions: the English auction held on “www.itsadeal.com” 15a; no bid is to be placed in the Dutch auction being held on “www.eBay.com” 15b; and a sealed-bid of value $130 is to be placed in the first-price sealed bid auction being held on “www.cheapaschips.com” 15c.

In method step 322 the agent 23 acts on this advice and places bids in the selected auctions. To actually place a bid, the agent posts a message to the Web site of the relevant actions detailing the auctions in which it wants to place bids, and the value of the bid in the case of the sealed-bid auction. The agent also includes the user's ID in this message, so that it can be used by the auction to identify the user, if necessary. Once the bids have been placed by the agent 23, it tests at Step 328 the stop condition to check whether the user's requirements have been met. If the placing of the above bids (together with any processors already acquired) has not resulted in the required number of processors, the algorithm 40 is run again in order to calculate further optimal bids, If the placing of the above bids (together with any processors already acquired) meets the user's requirements, or if all the auctions within the user's time window have closed, then the agent 23 has completed its task and stops.

Having described preferred embodiments of the present invention, it is to be appreciated that the embodiments in question are exemplary only and that variations and modifications such as will occur to those possessed of the appropriate knowledge and skills may be made without departing from the spirit and scope of the invention as set forth in the appended claims. For example, the present invention may also be used for different types of auctions. It is also possible to make the algorithm 42 more efficient by placing restrictions on the valuation function v. For example, if it is assumed that a consumer wants to buy exactly q items (no more and no less) then the size of W is known, and the third and most complex term of Equation (3) becomes zero. Furthermore, it is possible to calculate a priori the sunk cost (i.e., the money already paid out for the goods acquired) of the holding, H, and the benefit gained by adding elements of H to W. Because of this, the estimate of future utility becomes significantly easier to calculate.

1. A method of determining a bidding strategy for purchasing a plurality of goods from a plurality of different types of on-line auction, the method comprising:
accessing probabilistic belief models for each of the plurality of different types of auctions; considering combinations of bids in each specific auction type for the plurality of different types of auctions;
removing each possible bid of the combination of bids which fails to meet a predefined constraint of that type of auction for the plurality of different types of auctions, by use of the probabilistic belief models;
estimating the expected benefit of each possible combination of bids across different types of auctions by use of the probabilistic belief models; and
selecting the combination of bids across different types of auction which provides the highest expected benefit, for use as the bidding strategy.

2. A method according to claim 1, further comprising obtaining the closing prices of specific auctions in the plurality of different types of auctions for identical or similar goods to the plurality of goods, and creating a probabilistic belief model for at least each different type of auction from the closing price information.

3. A method according to claim 2, further comprising monitoring the status of the plurality of on-line auctions and retrieving auction data from each auction, the auction data including the current price for on-going auctions, and the closing price in closed auctions in which the bidding strategy has been implemented.

4. A method according to claim 1, wherein the plurality of different types of on-line auctions includes at least two of the following auction types English, Dutch and sealed-bid auctions.

5. A method according to claim 1, wherein the plurality of different types of on-line auction comprises a sealed-bid auction, and the considering step comprises generating a range of bid values between a maximum bid value (t_{cert} and a minimum bid value (t₀), where the minimum bid (t₀) is the largest bid that will definitely not win a good in the sealed bid auction, as specified by a probabilistic belief model.

6. A method according to claim 1 wherein the considering step comprises considering a combination which includes not making a bid in any one of the plurality of different types of on-line auction.

7. A method according to claim 1, wherein the plurality of different types of on-line auctions comprises an English and Dutch auction, and the removing step comprises removing a possible bid in a single auction which is not preferred by virtue of its current price and likelihood of winning at the current price as determined by the probabilistic belief model for that auction, a second auction being preferred to a first auction if the current price of the first auction is at least equal to the current price of the second auction, the likelihood of winning at the current price of the first auction is at most equal to the likelihood of winning at the current price of the second auction, and at least one of these conditions is not equal.

8. A method according to claim 1, wherein the plurality of different types of on-line auctions comprises a sealed-bid auction, and the removing step comprises removing a possible bid in an imminent sealed-bid auction which is not preferred by virtue of its bid value and the likelihood of winning with the respective bid value as determined by the probabilistic belief model for that auction, a second bid value in a second imminent sealed-bid auction being preferred to a first sealed bid value in a first imminent scaled-bid auction when the likelihood of wing the second auction with the second bid value at least equal to the likelihood of winning the first auction with the second bid value, the bid value in the first auction is at most equal to the bid value in the second auction, and at least one of these conditions is not equal.

9. A method according to claim 1, wherein the considering step further comprises setting an upper limit on the bid value for each type of the plurality of different types of auction.

10. A method according to claim 1, wherein the considering step finer comprises setting a minimum bid value which guarantees winning an auction for any Dutch and/or English auction, or a minimum bid value of zero for any sealed-bid value auction.

11. A method according to claim 10, wherein the estimating step comprises determining a maximum value Emax of an estimate of the future benefit by the following algorithm:
utilityEstimate(k,A,H,x) {
Emax:=0;
for each G δH {
for i=1 to |A\H| 55
Emax:=max (Ecert (GχLi(A,H)) (k,A,H,x), Emax);}
} return Emax;}
where k is the number of goods purchased in the auctions in which the bidding strategy has been implemented; A is the set of auctions determined by the considering step; H is the set of auctions in which the winning bid is held in auctions in which the bidding strategy has been implemented; x is the vector of current prices in the set of auctions A; G is an individual auction in the set of auctions H; EA is the maximum value of the estimated future benefit; Lᵢ(A,H) is a function returning the set of auctions comprising the first i elements of L(A,H), where L(A,H) is a list of auctions not in the set of holdings H arranged in order of increasing price; and E_{cert} is the estimate of future benefit where a certain purchase threshold t_{cert}(a) is defined as the minimum threshold which will guarantee a purchase in an auction a, where t_{cert}(a)=min {x|Pₐ(x)=1} and where Pₐ(x) is the probability of a bid x winning in auction a as determined by the probabilistic belief model for that auction.

12. A method according to claim 1 where E_{cert} is given by the following expression for a specific auction a:
$$\begin{matrix}{E}_{cert} ( W ) ( k , A , H , \underline{x} ) = ( v \vert W \vert + k ) - {X}_{W} ( {\underline{t}}_{cert} \vert \underline{x} ) + \\ {\sum }_{S ⋐ H \backslash W} {P}_{H \backslash W} ( S , \underline{x} \vert \underline{x} ) ( v \vert W + S \vert + k ) - \\ ( v \vert W \vert + k ) ) - \\ {\sum }_{a ∈ H \backslash W} {X}_{a} ( \underline{x} ( a ) \vert \underline{x} ( a ) ) {P}_{a} ( \underline{x} ( a ) \vert \underline{x} ( a ) ) ,\end{matrix}$$
where W is the subset of auctions which are currently being played, X is the amount of money to be paid if a bid wins, v is the value of the goods, and S is the set of sealed-bid auctions.

13. A method according to claim 9, wherein the estimating step comprises determining an estimate of the future benefit E_{T} by the following expression.
$${E}_{r} ( k , A , H , \underline{x} ) = {\sum }_{W ⋐ A}^{} {P}_{A} ( W , \underline{t} \vert \underline{x} ) ( v \vert W \vert + k ) - {X}_{W} ( \underline{t} \vert \underline{x} ) ,$$
where t is the vector of fixed thresholds; k is the number of goods purchased in the auctions in which the bidding strategy has been implemented; A is the set of auctions determined by the considering step; H is the set of auctions in which the winning bid is held in auctions in which the bidding strategy has been implemented, x is the vector of current prices in the set of auctions A; W is the subset of auctions which are currently being played; v is the value of the goods; and X is the amount of money to be paid if a bid wins.

14. A method of bidding in a plurality of different types of on-line auctions to acquire a plurality of goods, the method comprising determining a bidding strategy by
accessing probabilistic belief models for each of the plurality of different types of auctions; considering combinations of bids in each specific auction type for the plurality of different types of auctions;
removing each possible bid of the combination of bids which fails to meet a predefined constraint of that type of auction for the plurality of different types of auctions, by use of the probabilistic belief models;
estimating the expected benefit of each possible combination of bids across different types of auctions by use of the probabilistic belief models; and
selecting the combination of bids across different types of auction which provides the highest expected benefit, for use as the bidding strategy;
and executing the bidding strategy with the plurality of on-line auctions.

15. A method according to claim 14, further comprising updating the probabilistic belief models of the different types of auctions with the results of the implemented bidding strategy at the different types of auctions.

16. A system for determining a bidding strategy for purchasing a plurality of goods from a plurality of different types of on-line auction, the system comprising: probabilistic belief models for each type of different auction; and processing means arranged to: access the probabilistic belief models for each of the plurality of different types of auctions; consider combinations of bids in each specific auction type for the plurality of different types of auctions; remove each possible bid of the combination of bids which fails to meet a predefined constraint of that type of auction for the plurality of different types of auctions, by use of the probabilistic belief models; estimate the expected benefit of each possible combination of bids across different types of auctions by use of the probabilistic belief models; and select the combination of bids across different types of auction which provides the highest expected benefit, for use as the bidding strategy.

17. A data carrier comprising a computer program arranged to configure a computer to implement a method of determining a bidding strategy for purchasing a plurality of goods from a plurality of different types of on-line auction, the method comprising:
accessing probabilistic belief models for each of the plurality of different types of auctions;
considering combinations of bids in each specific auction type for the plurality of different types of auctions;
removing each possible bid of the combination of bids which fails to meet a predefined constraint of that type of auction for the plurality of different types of auctions, by use of the probabilistic belief models;
estimating the expected benefit of each possible combination of bids across different types of auctions by use of the probabilistic belief models; and
selecting the combination of bids across different types of auction which provides the highest expected benefit, for use as the bidding strategy.

18. A data carrier comprising a computer program arranged to configure a computer to implement a method of bidding in a plurality of different types of on-line auctions to acquire a plurality of goods, the method comprising determining a bidding strategy by
accessing probabilistic belief models for each of the plurality of different types of auctions; considering combinations of bids in each specific auction type for the plurality of different types of auctions,
removing each possible bid of the combination of bids which fails to meet a predefined constraint of that type of auction for the plurality of different types of auctions, by use of the probabilistic belief models;
estimating the expected benefit of each possible combination of bids across different types of auctions by use of the probabilistic belief models; and
selecting the combination of bids across different types of auction which provides the highest expected benefit, for use as the bidding strategy;
and executing the bidding strategy with the plurality of on-line auctions.
